(19) United States
(12) Patent Application Publication
(10) Pub. No.: US 2024/0216852 A1
(43) Pub. Date: Jul. 4, 2024

(54) SEALING DEVICE FOR A GAS SORPTION ROTOR OF AN AIR TREATMENT SYSTEM AND A GAS SORPTION ROTOR ARRANGEMENT FOR AN AIR TREATMENT SYSTEM

(71) Applicant: MUNTERS CORPORATION, Amesbury, MA (US)

(72) Inventor: Benjamin J. KALINOWSKI, Newton, NH (US)

(21) Appl. No.: 18/090,171

(22) Filed: Dec. 28, 2022

(51) Int. Cl. B01D 53/06; B01D 53/26

(52) U.S. Cl. CPC B01D 53/06; B01D 53/261; B01D 2253/108; B01D 2257/708; B01D 2257/80; B01D 2259/40088

(57) ABSTRACT

A sealing device for a gas sorption rotor of an air treatment system is configured to be arranged between rotor media of the rotor and a rotor cassette at least partly surrounding the rotor. The sealing device includes a sealing frame configured to be attached to the rotor cassette; a contact portion with a contact surface configured to be arranged in contact with the rotor media; and a resilient part, arranged between the sealing frame and the contact portion, such that the contact surface is adapted to be biased against a surface of the rotor media. The contact surface is formed of a metallic material.

### TECHNICAL FIELD

The present disclosure relates to a sealing device for a gas sorption rotor of an air treatment system, and a gas sorption rotor arrangement for an air treatment system comprising such a sealing device, as defined in the introductory parts of the independent claims.

### BACKGROUND ART

Air treatment systems of various kinds are commonly used for providing treated air into a defined space. Such air treatment systems normally comprise some sort of gas sorption device with a gas sorption element. One such air treatment system involves dehumidifying air using a gas sorption rotor, commonly a desiccant rotor, also referred to as a desiccant wheel. The rotor rotates and thereby presents the desiccant in the rotor to the process and regeneration airstreams of the air treatment system. Regeneration may also be referred to as reactivation.

The desiccant rotor commonly comprises a rotor media with finely divided desiccant, impregnated into a semi-ceramic structure, which in appearance can resemble corrugated cardboard that has been rolled up into the shape of a wheel. The rotor rotates slowly between the process and regeneration airstreams. The process air flows through the flutes formed by the corrugations and the desiccant rotor either adsorbs or absorbs the moisture. Then, as the wheel rotates into the regeneration airstream, the desiccant is heated by the hot regeneration air, and the desiccant releases its moisture into the regeneration air.

Following regeneration, the desiccant rotates back into the process airstream, where the process repeats.

The rotor is normally rotatably arranged within a rotor cassette. In order to avoid mixing of the airstreams and undesirable air leakage, a seal is used between the rotor cassette and the rotor. Such a seal is often silicone-based. However, silicone based seals are not able to withstand the sometimes very high temperatures of the regeneration airstream in certain applications, leading to deterioration and short technical lifespan of the seal. Even high-grade silicone is insufficient for temperatures in the regeneration section in some applications, where the temperature may exceed 200 degrees Celsius.

Even if the silicone were to withstand high temperatures for a brief time, frequent replacements of the seal would be needed which is both costly and time consuming. The temperature limits of silicone thus present a significant drawback in known sealing devices. Some synthetic rubber products, such as the fluoropolymer elastomer known by the brand name Viton, may withstand high temperatures but is costly to use.

Furthermore, manufacturing variances of the rotor and cassette components mean that the space between the rotor face and sealing surfaces is not always perfectly consistent. Consequently, using a dimensionally fixed seal material can result in drive motor system failures in the field, which can lead to costly repairs and refit expense.

### SUMMARY OF THE INVENTION

It is an object of the present disclosure to mitigate, alleviate or eliminate one or more of the above-identified deficiencies and disadvantages in the prior art and solve at least the above-mentioned problems.

Another object of the present disclosure is to achieve a sealing device that can withstand high temperatures, even exceeding 200 degrees Celsius, and a rotor arrangement comprising such a sealing device. Such a sealing device would extend the technical life span of the seal between the rotor media and the rotor cassette, as well as reduce warranty and repair costs. Additionally, it is an object of the present disclosure to reduce rework in normal seal installation as well as to reduce the amount of silicone required.

Furthermore, it is an object of the invention to provide a sealing device with a tolerance for manufacturing variances, thereby reducing the problems caused by components that deviate from the desired specifications.

According to a first aspect of the present disclosure, there is provided a sealing device for a gas sorption rotor of an air treatment system, the sealing device being configured to be arranged between the rotor media of the rotor and a rotor cassette at least partly surrounding the rotor, the sealing device comprising a sealing frame, configured to be attached to the rotor cassette; a contact portion with a contact surface configured to be arranged in contact with the rotor media; and a resilient part, arranged between the sealing frame and the contact portion, such that the contact surface is biased against a surface of the rotor media; wherein the contact surface comprises a metallic material.

It is advantageous to use a contact surface comprising a metallic material in the sealing device, since metallic materials can withstand the high temperatures that may arise in the rotor, for example in the regeneration section or purge section. Depending on the intended use of the sealing device, in particular concerning the temperatures that are expected in the intended application, different metallic materials may be considered. In some embodiments, the metallic material of the contact portion comprises a ferrous metallic material, preferably steel. Ferrous metallic materials such as steel exhibit properties that are suitable for the sealing device, especially in terms of heat resistance.

According to some embodiments, the contact surface consists of a metallic material. According to some embodiments, the contact surface consists of a ferrous metallic material. According to some embodiments, the contact surface consists of a steel material. According to some embodiments, the contact surface consists of metal. According to some embodiments, the contact surface consists of steel.

The gas sorption rotor can suitably be a desiccant rotor such as an adsorption rotor or and absorption rotor. The air treatment system can suitably be a dehumidification system. In addition to dehumidification, the air treatment system may be a system for removing volatile organic compounds (VOCs) from the air. The desiccant used in the rotor may be a zeolite hydrophobic material such as a zeolite.

The sealing device is particularly suitable for high temperature regeneration applications due to the contact surface comprising a metallic material. It is possible to provide such a sealing device for the regeneration sector of the gas sorption rotor, while the process sector could be provided with a prior art silicone seal. Thereby, the sealing device and sealing arrangement according to the present disclosure provides a cost-efficient and flexible solution to high temperature applications.

The sealing device according to the present disclosure, with a resilient part biasing a contact surface against the rotor media, is suitable and beneficial to use for all rotor applications, even if there is no requirement for resistance against high temperatures, since such a sealing device allows for relaxed manufacturing tolerances and requires a reduced amount of silicone seal material.

The resilient part may be configured such that is acts as a barrier between the sealing frame and the contact portion of the sealing device, thereby forming a part of the gastight seal between the rotor cassette and the rotor media. In other words, the resilient part may cover the space between the sealing frame and contact portion so that no gas may pass through the sealing device. It is, however, possible to achieve the gastight seal between sealing frame and contact portion by other means, such as by arranging a suitably shaped gastight component between sealing frame and contact portion that is not a part of the resilient portion. It is also possible to eliminate the space between the sealing frame and the contact portion by extending the contact portion and/or sealing frame so that they abut each other.

The resilient part may comprise at least one biasing element attached to the contact portion on one side and to the sealing frame on another side. Furthermore, the resilient part may comprise a plurality of biasing elements. In such an example, the biasing elements may be distributed along the sealing device in order to achieve an even seal against the rotor surface. In an example, the biasing elements are evenly distributed along the sealing device, such that the spacing between two biasing elements is the same along the sealing device. In other examples, the biasing elements are unevenly distributed along the sealing device. It may be beneficial to use an uneven spacing to, for example, take into account the geometry of the sealing device and/or the rotor. In all embodiments of the sealing device, regardless of the placement or number of biasing elements used, the biasing element assures that a force is exerted that pushes the contact portion towards the rotor media to ensure a tight seal against the rotor. The biasing element may be a spring, such as a helical spring. Other suitable biasing elements, such as silicone in the form of a sponge and/or a silicone tube that could be inflated with air, can also be used to assure that a force is exerted on the contact portion, which pushes the contact portion toward the rotor media and ensures the gas tight seal provided by the sealing device disclosed herein.

In one example of the present disclosure, the resilient part further comprises at least one retaining element and at least one retaining fastener securing at least one biasing element to the contact portion. Depending on the configuration of the sealing device, more than one retaining element can be used. In addition, depending on the configuration of the sealing device and/or of the retaining element, more than one retaining fastener can be used. Thus, the resilient part may further comprise a plurality of retaining elements and at least one retaining fastener securing at least one biasing element to the contact portion. In other examples, the resilient part further comprises at least one retaining element and a plurality of retaining fasteners securing at least one biasing element to the contact portion.

In addition, in some examples the resilient part further comprises a plurality of retaining elements and a plurality of retaining fasteners securing at least one biasing element to the contact portion.

The retaining element may be an elongated strip and/or the retaining fastener may be a rivet. In some examples, a plurality of retaining elements is used in the sealing device, for example by connecting a plurality of elongated strips in a gas tight manner. In other examples, the retaining element is a washer of a suitable type, such as a flat metallic washer, or a disc.

In other examples, the fastener is any other type of mechanical fastener, such as a screw, nut, bolt, or anchor. Furthermore, the fastener may comprise interlocking sheet metal pieces, mechanically held together to form a fastener.

According to some examples, the contact portion comprises a recess for receiving a distal end of the at least one retaining fastener when it extends through the contact portion. If a rivet is used as the retaining fastener, then the distal end of the fastener is the head of the rivet. If other retaining fasteners are used, the distal end corresponds to any part that protrudes though the contact portion. Arranging a recess on the contact portion is beneficial since it eliminates contact between any protruding distal end of a retaining fastener and the rotor media. Contact between a protruding piece, such as a distal end of the retaining fastener, and the rotor media could harm the rotor media and thereby affect the performance of the sealing device negatively.

According to some examples, the resilient part comprises at least one flexible sheet arranged between the sealing frame and the contact portion. Thereby, the at least one flexible sheet acts as a gastight barrier between the sealing frame and the contact portion of the sealing device. The flexible sheet may be an elongated sheet made of a flexible material. In an unfolded state, the flexible sheet may be substantially rectangular with two longitudinal edges and two lateral edges, where the longitudinal edges are longer than the lateral edges. It is possible to arrange one flexible sheet such that it at least partly surrounds the at least one biasing element and thereby protects the biasing element from adverse external effects, such as heat and humidity from the airflow passing through the rotor, or exposure to external environment outside the rotor. Furthermore, one flexible sheet may be arranged on each side of the biasing element such that the biasing element is protected from exposure to both the airflow through the rotor and the external environment. Furthermore, one flexible sheet may be arranged such that it covers both sides of the at least one biasing element, for example by attaching a centre portion to the sealing frame and each edge to the contact portion on each side of the biasing element.

By arranging a flexible sheet between the sealing frame and the contact portion, the durability and gastight properties of the sealing device are enhanced. The at least one flexible sheet may comprise fibres or threads forming a flexible weave that is chemically stable at temperatures at least up to 150 degrees Celsius. According to some embodiments, the at least one flexible sheet comprises fibres or threads forming a flexible weave that is chemically stable at temperatures at least up to 200 degrees Celsius. Advantageously, the flexible sheet may comprise fibres or threads forming a flexible weave that is chemically stable at temperatures at least up to 220 degrees Celsius. In some embodiments, the at least one flexible sheet comprises fibres or threads forming a flexible weave that is chemically stable at temperatures at least up to 250 degrees Celsius. Such heat resistant properties are beneficial since the temperatures in the regeneration section or purge section of some gas sorption rotors can reach very high temperatures, in some applications even exceeding 200 degrees Celsius. Currently, in some applications, the temperature in the regeneration or purge section can reach around 220 degrees Celsius. It is therefore beneficial to equip the sealing device of the present disclosure with components that can withstand temperatures exceeding 220 degrees.

The flexible sheet may be a woven stainless steel sheet. In another example, the flexible sheet may be an aramid sheet, preferably a poly-paraphenylene terephthalamide sheet, also referred to as Kevlar. In yet another example, the flexible sheet is a heat-resistant rubber sheet. The material chosen for the flexible sheet should advantageously be both heat-resistant and flexible. Furthermore, it is advantageous to use a material that is resistant to corrosion in the air treatment system environment, in order to improve the durability of the sealing device. The before-mentioned materials, i.e. woven stainless steel sheets and aramid sheets (such as poly-paraphenylene terephthalamide sheets), all possess such beneficial properties and are thus suitable for use in the sealing device according to the present disclosure.

Furthermore, the at least one flexible sheet may be configured to be arranged between the retaining element and the contact portion along at least one edge of the flexible sheet. Thereby, the flexible sheet may be kept efficiently in a correct position, which enhances the durability and gas tightness of the seal by minimizing the risk of gaps appearing between the contact portion and the sealing frame. In some examples, the retaining element may be a high density composite, manufactured as a feature of the flexible sheet.

The shape of the sealing device may substantially correspond to the circumference of a circle sector. In some examples, the shape of the sealing device corresponds to the cross-sectional shape of a regeneration section of the gas sorption rotor.

According to the first aspect of the present disclosure, there is also provided a gas sorption rotor arrangement for an air treatment system comprising a gas sorption rotor. The gas sorption rotor comprises a rotor media; a rotor cassette at least partly surrounding the rotor media, and a sealing device, according to any of the examples described herein, arranged between the rotor media and the rotor cassette. In such a gas sorption rotor arrangement, one sealing device may be arranged on each side of the rotor media. In other words, one sealing device may be arranged on each outward facing surface of the rotor media, i.e. one sealing device on the process side and one sealing device on the regeneration side.

Advantageously, the sealing device is arranged to seal a regeneration section of the gas sorption rotor. The regeneration section, which can also be referred to as a reactivation section, denotes the section of the gas sorption rotor through which the regeneration airflow passes. The process section, through which the process airflow passes, may also be equipped with the sealing device of the present disclosure. However, due to the flexible configuration of the sealing device, it is possible to equip the gas sorption rotor with a sealing device according to the present disclosure on parts of the surface of the rotor, while using a conventional seal on other parts of the surface. Since the temperature requirement may not necessarily be as high in the process section as in the regeneration section, it may be suitable to use a sealing device according to the present disclosure in the regeneration section and a conventional seal in the process section. In another example, a sealing device according to the present disclosure may be used in the regeneration section and the purge section of the gas sorption rotor, while using a conventional sealing device to seal the process section. However, since the sealing device also provides the benefit of a gas tight seal with a tolerance for manufacturing variances, when components of the gas sorption rotor and rotor cassette deviate from the desired specifications, it is advantageous to use the sealing device even when the heat resistant properties are not necessary.

It is to be understood that all the features and advantages described with regard to the sealing device are also applicable to the gas sorption rotor arrangement.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Furthermore, the words “comprising”, “including”, “containing” and similar wordings do not exclude other elements or steps.

### BRIEF DESCRIPTION OF THE DRAWINGS

The above objects, as well as additional objects, features and advantages of the present disclosure will be more fully appreciated by reference to the following illustrative and non-limiting detailed description of example embodiments of the present disclosure, when taken in conjunction with the accompanying drawings.

FIG. 1 schematically illustrates a gas sorption rotor with a regeneration section and a process section;

FIG. 2 schematically illustrates a rotor cassette that at least partly encloses a gas sorption rotor;

FIGS. 3A-3C schematically illustrate a sealing device according to examples of the present disclosure;

FIGS. 4A-4C schematically illustrate a sealing device according to examples of the present disclosure.

FIGS. 5A and 5B each schematically illustrate a gas sorption rotor arrangement according to examples of the present disclosure;

FIGS. 6A and 6B each schematically illustrate a gas sorption rotor arrangement according to examples of the present disclosure;

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

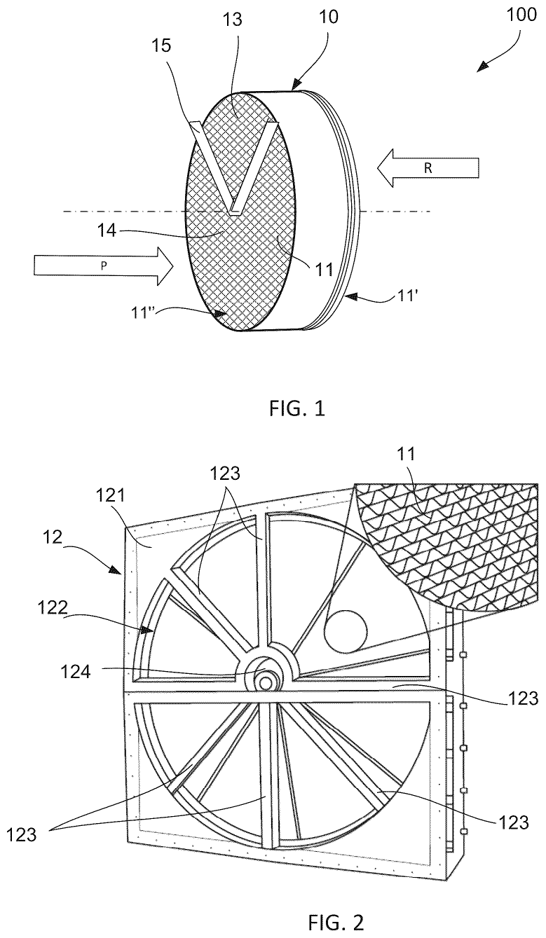

FIG. 1 schematically illustrates a gas sorption rotor 10 of an air treatment system 100 with a rotor media 11. Such gas sorption rotors are well known in the art and normally comprise at least one regeneration section 13 and one process section 14. In addition, rotors may include a purge section (not shown). A divider such as divider 15 shown in FIG. 1 separates the regeneration section 13 from the process section 14. Although only one regeneration section is shown in FIG. 1, the disclosure herein is also compatible with rotors having several and/or divided regeneration sections. Furthermore, the disclosure herein is compatible with rotors having separated purge zones and/or other divisions of the rotor. The rotor 10 in FIG. 1 is identical on both sides, such that the surfaces 11′ and 11″ of the rotor media 11 have the same configuration. The arrows P and R in FIG. 1 represent the flow of process air through the process section 14 and regeneration air through the regeneration section 13, respectively.

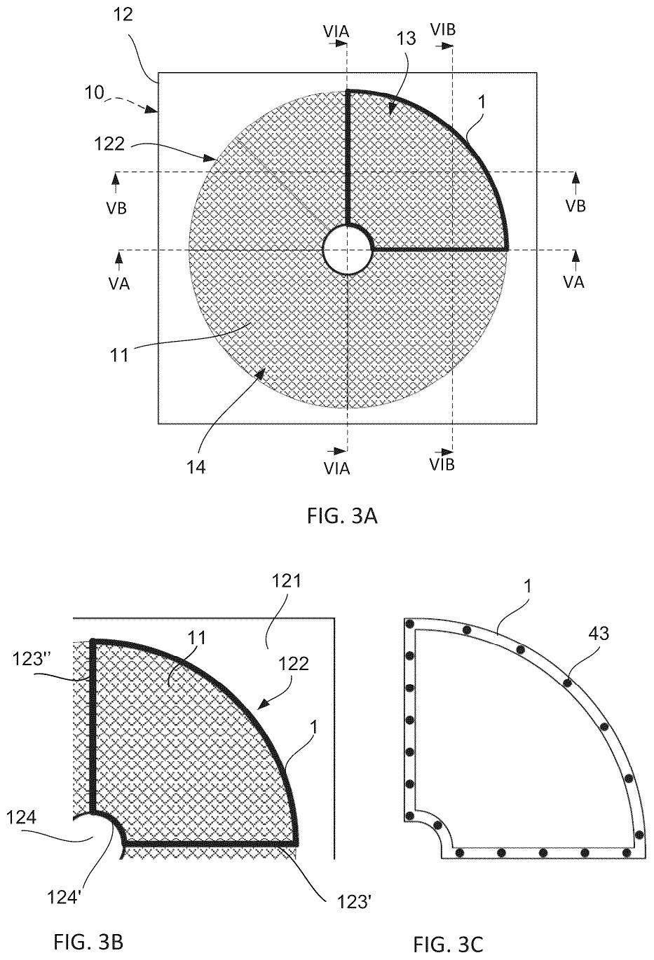

FIG. 2 schematically illustrates a rotor cassette 12 that, at least partly, encloses a rotor 10. The cassette as shown in FIG. 2 has a main body 121, and a central opening 122 divided by a plurality of bars 123. Such bars may also be referred to as spokes, ribs, spindles or any other term relating to elongated elements extending across an opening in the rotor cassette 12. In the center of the central opening 122, a hub 124 is shown.

Rotor cassettes such as rotor cassette 12 shown in FIG. 2 are known in the art and the disclosure herein is adaptable to fit any known types and configurations of rotor cassettes. The cassette 12 in FIG. 2 is shown from one side and can look the same or different on the opposite side, depending on the use of the rotor cassette 12.

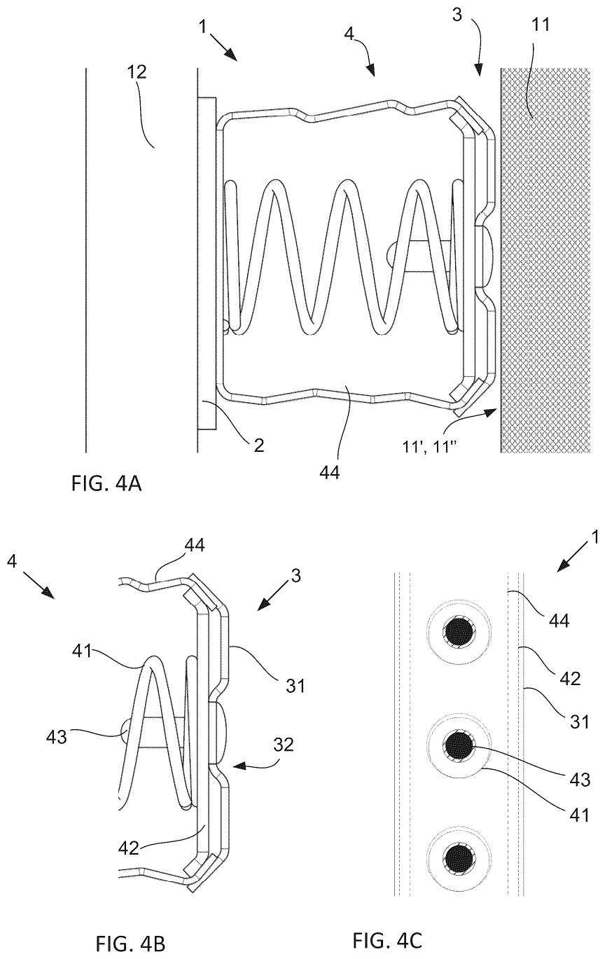

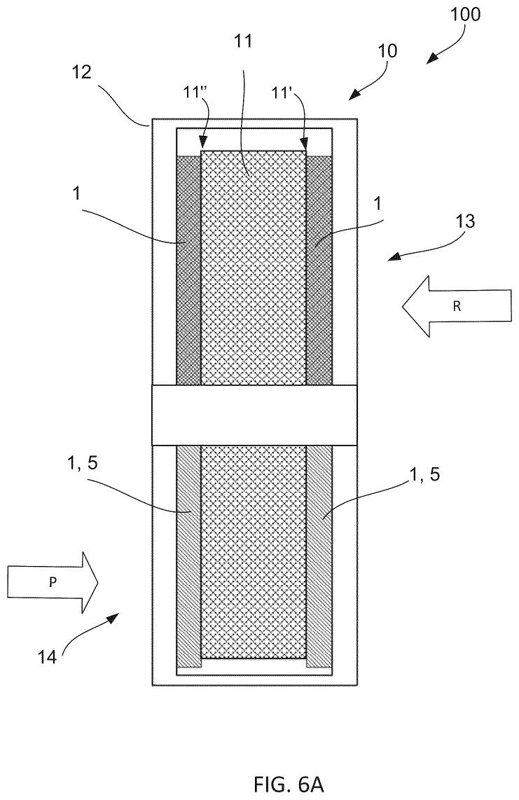

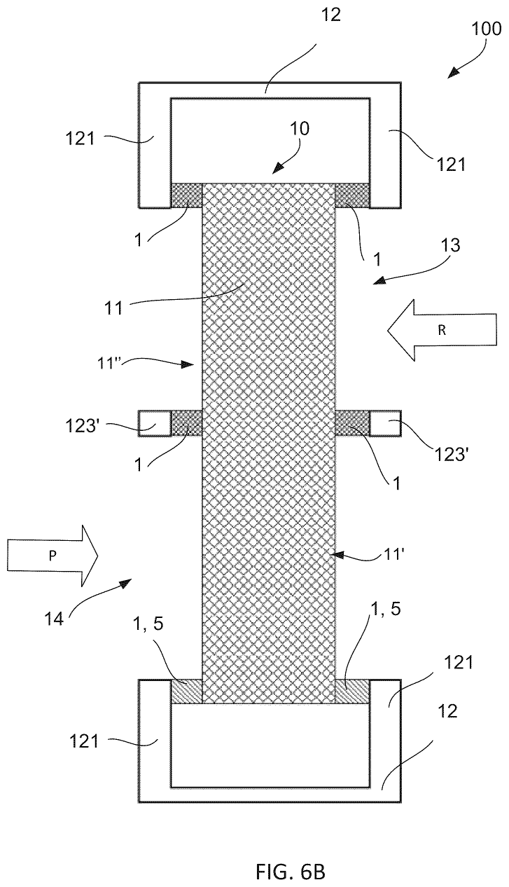

FIGS. 3A-C schematically illustrate a sealing device 1 according to examples of the present disclosure. The lines VA-VA, VB-VB, VIA-VIA and VIB-VIB in FIG. 3A show the position of cross-sections shown in FIGS. 5A, 5B, 6A and 6B, respectively.

In FIG. 3A, the position of the sealing device 1 is shown schematically in the rotor cassette 12, which at least partly encloses the rotor 10. In FIG. 3A, the rotor cassette 12 is shown in a front view. In the exemplary embodiment shown in FIG. 3A, the rotor 10 has a regeneration section 13 substantially in the shape of a circle sector and the sealing device 1 is arranged along the circumference of the regeneration section 13.

As shown in FIG. 3B, the regeneration section 13 is delimited by the bars 123′ and 123″; by the rotor cassette main body 121 along the circumference of the central opening 122, and by the circumferential bar 124′ around the hub 124. The sealing device 1 is arranged between the members of the rotor cassette 12, i.e. the main body 121 and the bars 123′, 123″ and 124′, and the rotor media 11. Thus, the sealing device 1 seals the space between the rotor cassette 12 and the rotor media 11.

FIG. 3C shows a schematic front view of the sealing device 1 having the position and shape shown in FIGS. 3A and 3B. In FIG. 3C, possible positions for retaining fasteners 43 are shown along the sealing device 1.

In FIGS. 3A-C, the shape of the sealing device 1 substantially corresponds to the circumference of a circle sector. Thus, in the example shown, the shape of the sealing device 1 corresponds to the cross-sectional shape of the regeneration section 13 of the gas sorption rotor 10, which is also substantially a circle sector. It is, however, well within the inventive concept of the disclosure herein to provide a sealing device having other shapes and being shaped correspondingly to other possible sectors of the rotor. As an example, the sealing device can be used to seal a purge sector of a rotor. In such an example, the shape of the sealing device suitably corresponds to the cross-sectional shape of the purge section.

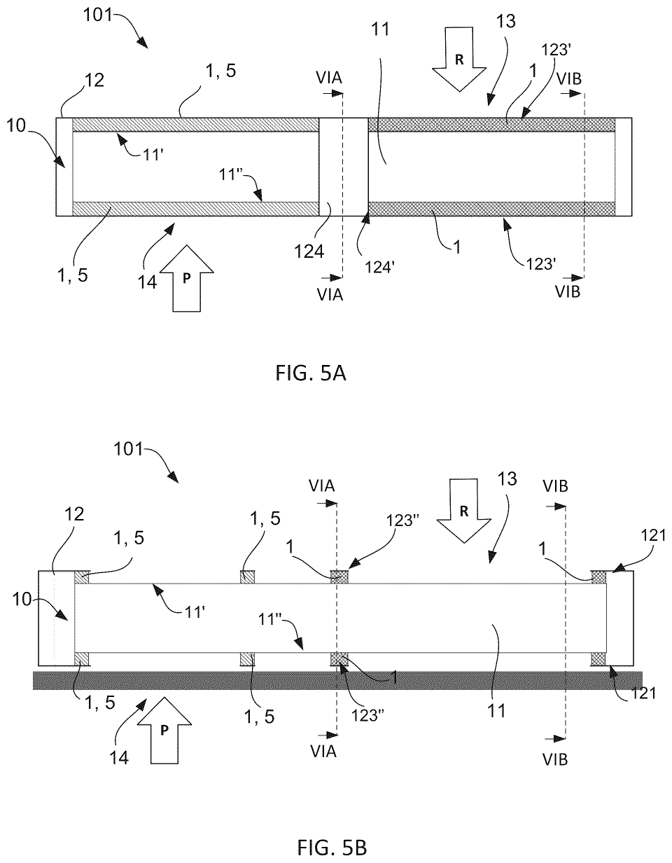

FIGS. 4A, 4B and 4C schematically illustrate the sealing device 1 according to examples of the present disclosure. FIGS. 4A and 4B are cross-sectional side views of the sealing device 1, and FIG. 4B shows details of the sealing device 1 shown in FIG. 4A, emphasizing the contact portion 3 and the resilient part 4. FIG. 4C is a top view of the sealing device 1 as seen from the rotor media surface 11′, 11″.

In FIG. 4A, the sealing device 1 comprises a sealing frame 2, configured to be attached to the rotor cassette 12; a contact portion 3 with a contact surface 31 (see FIG. 4B) configured to be arranged in contact with the rotor media 11; and a resilient part 4, arranged between the sealing frame 2 and the contact portion 3, such that the contact surface 31 is biased against a surface 11′, 11″ of the rotor media 11. In other words, the resilient part 4 urges the contact portion 3 against the surface 11′, 11″ of the rotor media 11, ensuring a gastight seal between the sealing device 1 and the rotor media 11. The sealing device 1 is arranged in a gastight manner against the rotor cassette 12, via the base of the resilient part 4 attached to the sealing frame 2. Thereby, a gastight seal is achieved between the rotor cassette 12 and the rotor media 11.

The contact surface 31 comprises a metallic material. Employing a metallic material, i.e. a material comprising metal, in the contact surface 13 ensures a durable seal that is able to withstand high temperatures, particularly in the regeneration section 13. Advantageously, the metallic material of the contact surface 31 is a ferrous metallic material, preferably steel. Other possible materials for the contact surface 31 include plastics or composites.

The sealing frame 2 is arranged to be attached to the rotor cassette 12. The sealing frame 2 can be attached to the rotor cassette 12 in any suitable way with any suitable fastening means, such as screws, structural adhesives or tapes. As would be understood by a person skilled in the art, the sealing frame 2 must be attached to the rotor cassette 12 in a manner that maintains the gastight properties of the sealing device. The sealing frame 2 may comprise a spring track (not shown). Such a spring track can be used for retrofits or to enable the sealing device to be manufactured as a sub-assembly.

In the exemplary embodiment shown in FIG. 4B, the resilient part 4 comprises at least one biasing element 41 attached to the contact portion 3 on one side and to the sealing frame 2 on another side. Any suitable element capable of applying a biasing force that urges the contact portion 3 towards the rotor media can be used as the biasing element 41. In the example of FIG. 4B, the biasing element is a spring in the form of a helical spring. Other suitable biasing members include silicone in the form of a sponge, and/or a silicone tube that could be inflated with air.

In the example embodiment, the resilient part 4 further comprises at least one retaining element 42 and at least one retaining fastener 43 securing the at least one biasing element 41 to the contact portion 3. Any suitable means for retaining and securing the biasing element can be used. In FIGS. 4A and 4B, the retaining element 42 is an elongated strip and the retaining fastener 43 is a rivet. Other suitable fasteners suitable to use as the retaining fastener 43 include mechanical fasteners of various types, such as screws or sheet metal features that interlock.

In the example of FIG. 4B, the contact portion 3 comprises a recess 32 for receiving a distal end of the at least one retaining fastener 43, i.e. the head of the rivet in this example, when it extends through the contact portion 3. Contact between the retaining fastener 43 and the rotor media 11 could harm the rotor media and/or negatively affect the performance of the sealing device. Thus, the recess 32 is beneficial since it eliminates contact between the retaining fastener 43 and the rotor media 11, while at the same time allowing for a secure attachment between the contact portion 3, the resilient part 4 and the sealing frame 2.

In FIGS. 4A-C, the resilient part 4 comprises at least one flexible sheet 44 arranged between the sealing frame 2 and the contact portion 3. The at least one flexible sheet 44 acts as a gastight barrier between the sealing frame 2 and the contact portion 3 of the sealing device 1. In the examples shown, the flexible sheet 44 is an elongated sheet, having a substantially rectangular shape in an unfolded state, with two longitudinal edges and two lateral edges, where the longitudinal edges are longer than the lateral edges. Such a flexible sheet 44 should ideally comprise fibres or threads forming a flexible weave that is chemically stable at temperatures at least up to 150 degrees Celsius. According to some embodiments, the flexible sheet 44 comprises fibres or threads forming a flexible weave that is chemically stable at temperatures at least up to 200 degrees Celsius. Advantageously the flexible sheet comprises fibres or threads forming a flexible weave that is chemically stable at temperatures up to at least 220 degrees Celsius or even exceeding 220 degrees Celsius. For example, it is beneficial that the flexible sheet is chemically stable at temperatures up to 250 degrees Celsius. Preferred materials for the flexible sheet 44 that are known to fulfil the requirements needed in the sealing device according to at least some of the embodiments of the present disclosure are:
a woven stainless steel sheet;
an aramid sheet, preferably a poly-paraphenylene terephthalamide sheet, commonly referred to by the brand name Kevlar; or
a heat-resistant rubber sheet.

The flexible sheet 44 may also be a formed, thin, stainless steel sheet or an extruded tube material. However, any material fulfilling the requirements of the sealing device 1, in particular relating to temperature and flexibility, may advantageously be used.

As shown in FIGS. 4A-C, the at least one flexible sheet 44 may be arranged such that it at least partly surrounds the at least one biasing element 41, thereby protecting the biasing element 43 from adverse external effects. Heat and/or humidity may negatively affect the durability of the biasing element 41, for example. The surroundings of the biasing element 41 may be different on the side of the biasing element 41 facing the hub 124 of the rotor 10 and the side of the biasing element 41 facing away from the hub 124. Thus, in some applications it may be particularly beneficial to use the flexible sheet 44 in certain parts of the rotor 10, while other sealing materials or methods may be used in other areas. In some applications, however, it may be desirable to arrange one flexible sheet 44 according to the present disclosure on each side of the biasing element 41 to protect it from exposure to both the airflow through the rotor and the external environment, as is the case in the example shown in FIGS. 4A-C.

FIG. 4A shows an example where one elongated flexible sheet 44 is attached at its centre to the sealing frame 2. Each longitudinal side edge of the flexible sheet 44 has been folded in a direction toward the rotor and is attached to the contact portion 3, such that it covers both sides of the at least one biasing element 43. Thus, the area between the contact portion 3 and the sealing frame 2 is covered by one flexible sheet 44, on both sides of the biasing element 41. Although not shown in the figures, it is possible to arrange two separate flexible sheets 44, between the sealing frame 2 and the contact portion 3. In such examples, one longitudinal edge of the flexible sheet 44 is attached to the sealing frame 2, while the other longitudinal edge is attached to the contact portion 3.

In the examples shown in FIGS. 4A-C, the flexible sheet 44 is arranged between the retaining element 42 and the contact portion 3, on a lower surface of the contact surface 31, along both edges of the flexible sheet 44, as discussed above.

In the example shown in FIGS. 4A-C, the contact surface 31 is designed in one piece, and the flexible sheet 44 is thus sandwiched between the lower surface of the contact surface 31 (i.e. the side facing away from the rotor media 11) and an upper side of the retaining element 42 (i.e. the side facing in the direction of the rotor media 11).

Although not shown in the figures, a high-density composite, manufactured as a feature of the flexible sheet, may be used as a retaining fastener.

FIG. 4C, which is a top view of a section of the sealing device 1, shows the edges of the elongated flexible sheet 44, in a position between the edges of the retaining element 42, in the shape of an elongated strip, and the edges of the contact surface 31 which is also in the shape of an elongated surface. The plurality of retaining fasteners 43 shown are evenly distributed longitudinally along the section of the sealing device 1, retaining the evenly distributed biasing elements in place in the sealing device.

FIGS. 5A and 5B each schematically illustrate a gas sorption rotor arrangement 101 for an air treatment system 100 according to examples of the present disclosure. The figures are schematic cross-sectional views of the gas sorption rotor arrangement 101, taken along lines VA-VA and VB-VB in FIG. 3A, respectively. The gas sorption rotor arrangement 101 shown in FIGS. 5A and 5B comprises a gas sorption rotor 10 comprising a rotor media 11, a rotor cassette 12 at least partly surrounding the rotor media 11, and a sealing device 1 according to the disclosure herein arranged between the rotor media 11 and the rotor cassette 12.

In the example embodiment shown in FIGS. 5A and 5B, the rotor cassette 12 at least partly encloses the rotor 10 on both sides and a sealing device 1 is arranged on each side of the rotor media 11. In other words, the sealing device 1 is arranged on each outward facing surface 11′, 11″ of the rotor media 11, i.e. one sealing device 1 on the surface 11″ of the rotor 11 facing the process air flow P and one sealing device 1 on the surface 11′ of the rotor 11 facing the regeneration air flow R. Thus, one sealing device 1 is arranged on the process side of the rotor 11 and one sealing device 1 is arranged on the regeneration side of the rotor 11.

In FIGS. 5A and 5B, the rotor cassette 12 is identical on both sides of the rotor media 11 and a sealing device 1 is arranged between the rotor media 11 and the rotor cassette 12 on each side, so that one sealing device 1 is biased against each of the two opposite surfaces 11′ and 11″ of the rotor media 11. In FIGS. 5A and 5B, the sealing device 1 is arranged to seal a regeneration section 13 of the gas sorption rotor 10, through which the regeneration airflow passes, as indicated by the arrow R. As previously mentioned, the sealing device 1 is also particularly suitable for sealing a purge section of the rotor 10. The process section 14, through which the process airflow passes, as indicated by the arrow P, can also be equipped with the sealing device 1 of the present disclosure. However, since the temperature requirement may not necessarily be as high in the process section 14 as in the regeneration section 13, it is also possible to use a conventional seal 5 in the process section 14, as shown in FIGS. 5A and 5B. Nonetheless, since the sealing device also provides the benefit of a gastight seal with a tolerance for manufacturing variances, when components of the gas sorption rotor and rotor cassette deviate from the desired specifications, it is advantageous to use the sealing device even when the heat resistant properties are not necessary.

As mentioned above, the cross-section in FIG. 5A is taken along line VA-VA, shown in FIG. 3A. FIG. 5A thus shows the gas sorption rotor arrangement 101 comprising a sealing device 1 arranged along the bar 123′ of the rotor cassette 12. FIG. 5A also shows the hub 124, against which the sealing device 1 seals.

As mentioned above, the cross-section in FIG. 5B is taken along line VB-VB, shown in FIG. 3A. FIG. 5B thus shows the gas sorption rotor arrangement 101 comprising a sealing device 1 arranged along the bar 123″ and the main body 121 of the rotor cassette 12.

Lines VIA-VIA and VIB-VIB in FIGS. 5A and 5B represent the cross-sections shown in FIGS. 6A and 6B, respectively.

FIGS. 6A and 6B each schematically illustrate a gas sorption rotor arrangement 101 according to examples of the present disclosure. FIG. 6A shows a schematic cross-section taken along line VIA-VIA in FIGS. 3, 5A and 5B. FIG. 6B shows a schematic cross-section taken along line VIB-VIB in FIGS. 3, 5A and 5B.

FIG. 6A shows the gas sorption rotor arrangement 101 comprising the sealing device 1 arranged along the bar 123″ on each side of the rotor cassette 12, sealing the regeneration section 13 of the rotor 10, through which the regeneration airflow R passes, as indicated by the arrow R. FIG. 6A also shows the hub 124, against which the sealing device 1 seals the regeneration section 13 on the upper side of the rotor 10, as seen in the figure. The process section 14, through which the process airflow passes, as indicated by the arrow P, can be sealed using the sealing device 1 or a conventional seal 5.

FIG. 6B shows the gas sorption rotor arrangement 101 comprising the sealing device 1 arranged along the bar 123′ and the main body 121 of the rotor cassette 12, on each side of the rotor cassette 12. In the example in FIG. 6B, the sealing device 1 or a conventional seal 5 can be used to seal the space between the respective surfaces 11′, 11′,′ of the rotor media 11 and the main body 121 of the rotor cassette 12 in the process section 14 of the rotor 10, through which the process airflow passes, as indicated by the arrow P.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A sealing device for a gas sorption rotor of an air treatment system, the sealing device being configured to be arranged between rotor media of the rotor and a rotor cassette at least partly surrounding the rotor, the sealing device comprising:
a sealing frame configured to be attached to the rotor cassette;
a contact portion with a contact surface configured to be arranged in contact with the rotor media; and
a resilient part, arranged between the sealing frame and the contact portion, such that the contact surface is adapted to be biased against a surface of the rotor media,
wherein the contact surface comprises a metallic material.

2. The sealing device according to claim 1, wherein the metallic material comprises a ferrous metallic material, preferably steel.

3. The sealing device according to claim 1, wherein the resilient part comprises at least one biasing element attached to the contact portion on one side and to the sealing frame on another side.

4. The sealing device according to claim 3, wherein the resilient part further comprises at least one retaining element and at least one retaining fastener securing the at least one biasing element to the contact portion.

5. The sealing device according to claim 4, wherein the retaining element comprises an elongated strip and/or the retaining fastener is a rivet.

6. The sealing device according to claim 4, wherein the contact portion comprises a recess for receiving a distal end of the at least one retaining fastener when it extends through the contact portion.

7. The sealing device according to claim 1, wherein the resilient part comprises at least one flexible sheet arranged between the sealing frame and the contact portion.

8. The sealing device according to claim 7, wherein the at least one flexible sheet comprises fibers or threads forming a flexible weave that is chemically stable at temperatures at least up to 150 degrees Celsius, preferably at least up to 200 degrees Celsius

9. The sealing device according to claim 7, wherein the flexible sheet comprises one of a woven stainless steel sheet; an aramid sheet, preferably a poly-paraphenylene terephthalamide sheet; or a heat-resistant rubber sheet.

10. The sealing device according to claim 7, wherein the at least one flexible sheet is configured to be arranged between the retaining element and the contact portion along at least one edge of the flexible sheet.

11. The sealing device according to claim 1, wherein the shape of the sealing device substantially corresponds to the circumference of a circle sector.

12. The sealing device according to claim 1, wherein the shape of the sealing device corresponds to the cross-sectional shape of a regeneration section of the gas sorption rotor.

13. A gas sorption rotor arrangement for an air treatment system comprising:
a gas sorption rotor comprising a rotor media;
a rotor cassette at least partly surrounding the rotor media; and
a sealing device according to claim 1 arranged between the rotor media and the rotor cassette.

14. The gas sorption rotor arrangement according to claim 13, wherein one sealing device is arranged on each side of the rotor media.

15. The gas sorption rotor arrangement according to claim 13, wherein the sealing device is arranged to seal a regeneration section of the gas sorption rotor.
